(19) United States
(12) Patent Application Publication
(10) Pub. No.: US 2002/0090217 A1
(43) Pub. Date: Jul. 11, 2002

(54) Sporting events broadcasting system

(76) Inventors: Daniel Limor, Netanya (IL); Alon Wallach, Ramat Gsn (IL); Achiam Ben Arve, Moshav Shilat (IL); Daniel Ben Menachem, Tel Aviv (IL); Nir Levy, Hod Hasharon (IL); Roberto Muller, Scarsdale, NY (US)

Correspondence Address: GOTTLIEB RACKMAN & REISMAN PC, 270 MADISON AVENUE, 8TH FLOOR, NEW YORK, NY, 100160601

(21) Appl. No.: 09/894,358

(22) Filed: Jun. 28, 2001

Related U.S. Application Data
(60) Provisional application No. 60/215,228, filed on Jun. 30, 2000.
(60) Provisional application No. 60/215,266, filed on Jun. 30, 2000.

(51) Int. Cl. G03B 17/48

(52) U.S. Cl. 396/429

(57) ABSTRACT

A system for broadcasting a sporting event related to one or more moving objects (such as race cars) includes a plurality of stations disposed along the objects' trajectory. Each station includes an automated camera unit. A central command post receives the location of each object and sends commands to the respective cameras to cover the objects as they move. The signals from the cameras is then mixed automatically at the central control post and used to generate several video signals. The programs are transmitted directly to broadcasters, or are distributed via the Internet.

### RELATED APPLICATIONS

This application claims priority to provisional application Ser. Nos. 60/215,228 and 60/215,266 filed Jun. 30, 2000.

### BACKGROUND OF THE INVENTION

A. Field of Invention

This invention pertains to a system for collecting video images (as used in this application the term video pictures also includes images as well as sounds) and data associated with a broadcasting event at a central location, processing the images and data and then transmitting or broadcasting the images and data to various locations. The system can be advantageously be used to broadcast sporting events involving fast-moving motor vehicles, such as a car race.

B. Description of the Prior Art

Sporting events are very popular with TV audiences throughout the world. People like to watch many different types of sporting events associated with their favorite teams, favorite sports, or just because they find these types of programs entertaining. As a result, in most viewing areas, one may watch sporting events on TV at anytime, day or night.

In order to maintain viewer interest and enhance the experience of watching a sporting event, it is important that the event be captured in a manner that helps the viewer identify with, and thus, at least vicariously, participate in the event. It has been found that the closer a viewer can identify with the actual participants or players of a sporting event, the more popular is the broadcast. The best way of providing such an intimate coverage of a sporting event is by presenting the event as it is sensed through the eyes and ears (and in the future, even other senses) of the players.

In order to achieve these goals, presently a sporting event program provider makes use of several crews for capturing the sporting event. Each crew consists of at least one cameraman and a video camera. The video pictures from each camera are then sent to a director who picks and chooses which shots are being broadcast. (To including data relevant to the sporting event is not common.) this type of arrangement is expensive and inaccurate, since it relies on the cameraman to be able to capture the action. Moreover, typically, using this arrangement, one can generate only a single broadcast.

### OBJECTIVES AND SUMMARY OF THE INVENTION

In view of the abovementioned disadvantages of the prior art, it is an objective of the present invention to provide a system that can collect video pictures and data of a particular sports event from different locations, automatically.

A further objective is to provide a system that is capable of providing a live video program of a high-speed sports event using automated cameras controlled from a central location.

Yet another objective is to provide a system wherein a moving object, such as race car, can be automatically tracked by several strategically placed video cameras, wherein each video camera can capture the images of a moving object based on information received by the camera regarding the location and velocity of the object.

A further objective is to provide a system capable of capturing the positions of several moving objects, transmitting video signals of each object and data associated with the object to a central location and then broadcast several programs from the central location, each program being associated with a specific moving object.

Other objectives and advantages of the invention shall become apparent from the following description of the invention. Briefly, the system constructed in accordance with this invention for generating a broadcast of an event related to one or more moving objects includes a plurality of stations positioned along the trajectory of the objects. Each station includes at least one automated video camera, which can receive commands and can be operated to cover an object as it moves in and around the event. A central command post receives data descriptive of the position of the objects relative to the stations, using for instances GPS systems. A processor at the central command post determines which station is most suited for covering each object. Preferably, several cameras are provided at each station, each camera being assigned to a particular objects. The objects may be provided with a fine-tuning transmitters such as infrared or pixel recognition and the stations may be provided with fine-tuning receivers. These fine-tuning elements may be used to confirm that the position of a particular has been properly detected.

Video signals from the camera units that are collected at the central command post are automatically mixed and used to generate several programs simultaneously. A different program may be generated in this manner for each object participating in the event. In addition, each object can be provided with its own additional camera unit, object sensors for detecting parameters related to the object such as its speed and other operational or mechanical parameters. If a driver or operator is involved, then additional sensors may be used to sense the physical condition of the driver. The video signals from the additional camera unit, and information from the sensors can be added to the programs for additional entertainment value.

### BRIEF DESCRIPTION OF THE DRAWINGS

FIG. 1 shows a diagrammatic representation of a racetrack with objects (i.e., race cars) running around a track and various elements of the system constructed in accordance with this invention to automatically broadcast the race;

FIG. 2A shows a somewhat diagrammatic representation of a typical station disposed on the track with a plurality of camera units;

FIG. 2B shows a block diagram of a typical camera unit on one of the stations of FIG. 2A;

FIG. 3 shows the equipment disposed in one of the objects running around the track of FIG. 1;

FIG. 4 shows a block diagram of the components of the central control post of FIG. 1;

FIG. 5 shows a flow chart for the acquisition of video signals for a particular car; and

FIG. 6 shows a block diagram for the system of FIGS. 1-4.

### DETAILED DESCRIPTION OF THE INVENTION

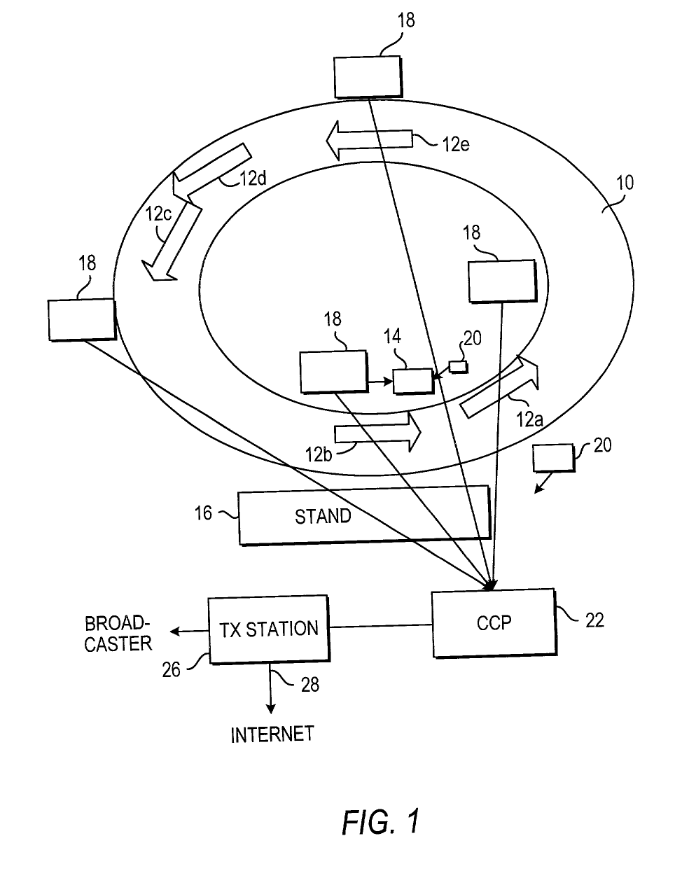

FIG. 1 shows somewhat diagrammatically a racetrack with a broadcasting system constructed in accordance with this invention. On this Figure, there is shown an oval track 10 on which there are a plurality of moving objects, such as race cars 12a, 12b, 12c, 12d, 12e running around in the counterclockwise direction. Also part of the track is a pit 14 used to service one or more of the cars 12, and a stand 16 for the spectators.

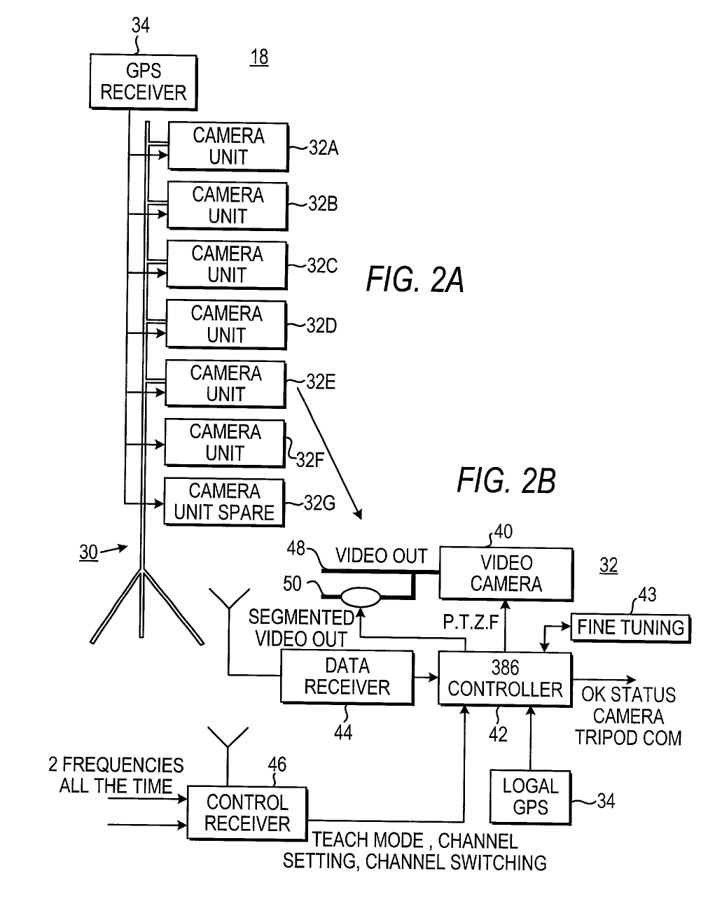

The system for broadcasting this race includes a plurality of automated camera stations 18 disposed about the track and consisting of several video cameras arranged and constructed to capture video images of the racing cars 12A-E, as discussed in more detail below in conjunction with FIGS. 2A and 2B. Additional auxiliary camera stations 20 may also be provided to capture video images of the activities in the pit 14, stand 16 and any other actions of interest to viewers. The number of camera stations 18 and 20 depends on the size of the track, the number of cars 12, and so on. The video signals from the video cameras are collected by a central control post (CCP) 22. The CCP 22 also receives data from the racing cars 12 as well as other outside sources such as race management. At the CCP all this data is collected, processed and used to generate broadcasts that may be stored, or transmitted to commercial TV studios or other entities by a transmitter station 24 over standard communication lines 26 and/or via the Internet over a high speed wired or wireless digital communication channel 28.

FIG. 2 shows a diagrammatic side elevation view of a typical camera station 18. The camera station includes a support 30 on which there are mounted a group of seven camera units 32A-32G and a GPS receiver 34. As seen in FIG. 2A, each camera unit (generically identified by the numeral 32) includes a video camera 40, a controller 42, a data receiver 44 and a control receiver 46. The video camera receives control signals P, T, Z, F (pan, tilt, zoom, focus) from the controller 42 that are used to control the operation of the video camera 40. In response, the video camera generates video signals either in a continuous stream on video out line 48 or as segmented video on line 50. Each camera may also be provided with a fine-tuning receiver 43 adapted to detect a fine-tuning source within a very narrow angle of view. The fine tuning receiver 43 may be coupled to the video camera 40 so that the two devices have identical (or at least similar) fields of view.

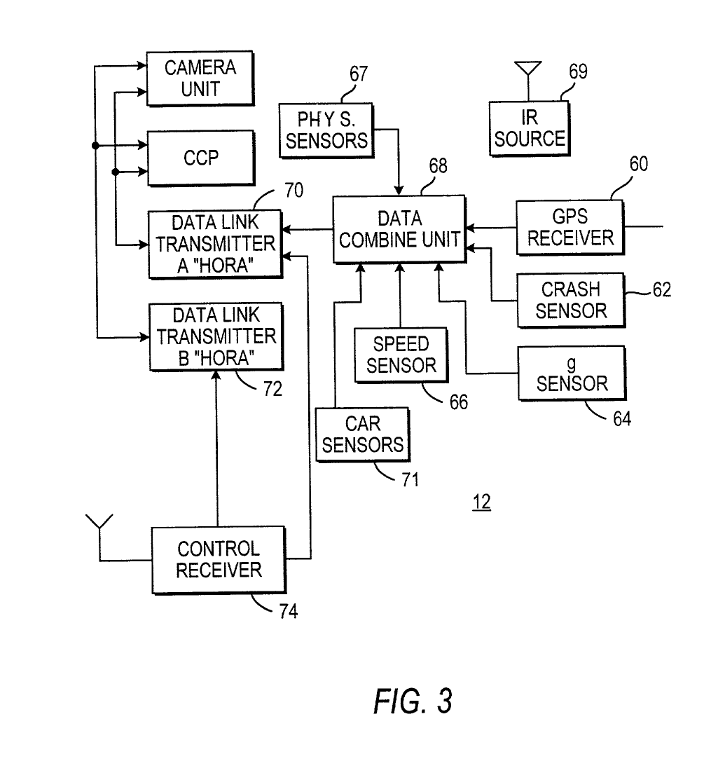

Referring now to FIG. 3, inside each of the racing cars 12 there is provided a GPS receiver 60, a crash sensor 62, a G-sensor 64 and a speed sensor 66. Optionally, other sensors may be provided as well, such as one or more physiological sensors 67 used to monitor the heart rate, blood pressure, temperature of the driver, and mechanical sensors 71 designed to sense various operational parameters of the car 12, such as oil pressure, engine speed, torque, water temperature, etc. The data from these sensors is combined by a data combine unit or multiplexer 68. In order to insure a secure transmission, two data transmitters 70, 72 are also provided for transmitting the data from the unit 68 to the cameras and the CCP 22 simultaneously. The operation of the car unit is controlled in through control data received from the CCP 22 via control receiver 74. Preferably receiver 74 is adapted to be coupled to the CCP 22 by two communication channels for the sake of redundancy. The control receiver 46 in the camera units 46 also uses two communication channels to communicate with the CCP. Also provided within the car 12 is a camera unit 76 which operates in response to control signals from the control receiver 74 and generates video signals transmitted to the CCP 22. This camera unit 76 operates in response to control signals from the control receiver 74 and generates video signals transmitted to the CCP 22. Finally a fine-tuning source 69 may be provided as well for the purposes described below.

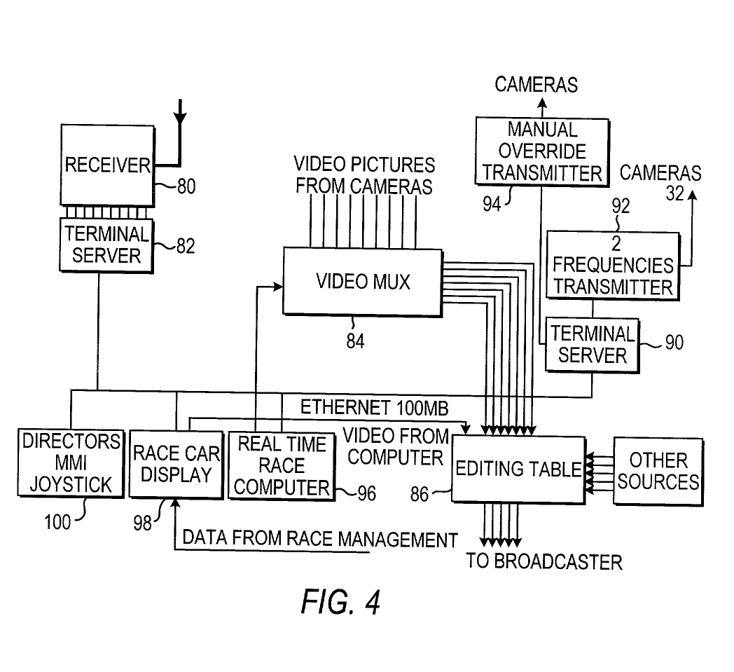

FIG. 4 shows the elements of the CCP 22. The CCP 22 includes a data receiver 80 that receives the data from cars via transmitters 70 or 72. This data is handled by a terminal server 82. The video signals from the camera units 32, the cameras at stations 20 and the camera units 76 from the racing cars are received by a video multiplexer 84. The multiplexer 84 may also receive audio signals from various external sources as well. These signals are transmitted to an editing table 86 where they are edited. The editing table 86 may also receive video signals from other sources 88. The signals to be transmitted to the viewers are then sent to transmitter 24.

The control signals to the camera units and the cars are transmitted through terminal server 90 and transmitter 92. Manual override control signals (discussed in more detail below) are transmitted from a transmitter 94.

FIG. 4 shows a real time race computer 96 used to track the progress of each of the cars 12 around the track using this data the race computer 96 switches automatically between the cameras covering the assigned car 12. It also compiles various other information such as time, average speed, position, etc. Based on this data a racecar display 98 may be used to generate a display indicating the positions of the cars in a manner similar to the one shown in FIG. 1. In addition, various other controls may be provide to assist directors in selecting and controlling various cameras and other apparatus, for example through a joystick 100.

The operation of the system is now described in conjunction with the drawings. Essentially the broadcasting of a car race is accomplished in three phases. First, video pictures (as used in this application the term video pictures also includes images as well as sounds) are taken by the various camera units, and data is collected from car, driver and outside sources Second, the video pictures and data are collected and processed at the CCP 22. Third, broadcast programs composed of the video signals and data are transmitted to commercial broadcasters or other entities.

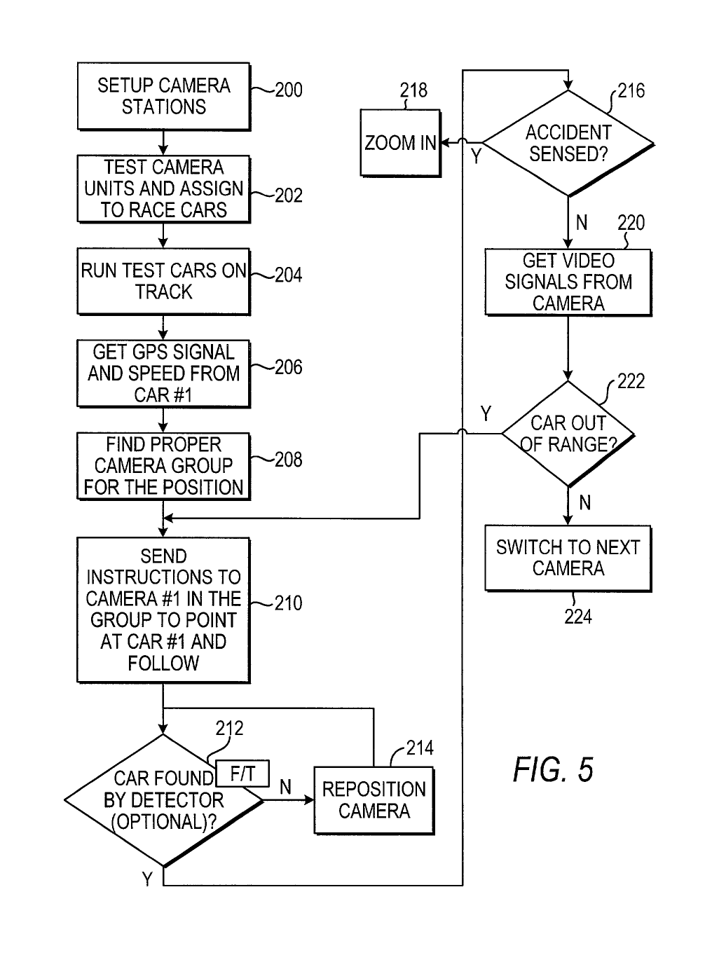

FIG. 5 shows a flow chart illustrating a preliminary phase during which the equipment is positioned around the track, as well as details of how video pictures are captured by the system. In step 200 the CCP is set up and the camera stations with the groups of cameras are positioned along the track 10. Next, in step 202 each of the camera units 32 is tested to insure that it is operational. Moreover camera units 32A-F are assigned to at least one of the racing cars. If there are more cars then some of the camera units may be assigned to cover more than one car. The camera assignment can be changed in the middle of the race by the CCP 22. Camera unit 32G is not assigned but is kept as a spare in case one of the other camera units fails or to cover other action. During this test, the position of each station is also determined from the signals generated by the GPS receivers 34.

In step 204 one or more test cars run the track 10 and the system 10 is tested to insure that all the equipment is functioning together. Any equipment that is not running properly is fixed, adjusted or replaced as required. The control scheme for following each car with designated camera units is also tested.

When the race starts, the participant cars 12A run around the track 10 and come into the field of view of at least one camera of each of the groups or stations. As the cars pass the stations, each camera unit 32 locates the car assigned to it and follows around the track. More particularly, in step 206, the current position of each car and its speed are obtained from GPS receiver 60 and sensor 66. It is desirable to obtain the speed in addition to the position of each car because there is some delay between the time that this data is obtained and the time that each camera unit 32 is moved or pointed toward the desired car. Since this delay is known, the expected position of the car can be estimated. This data processing is performed at the CCP 22.

Once the position of each car is known, in step 208 a determination is made as to which camera station 18 should be handling the car. This determination is based on the position of each station 18. In step 210, instructions are sent to the proper camera unit of the designated station including commands for orienting the respective camera unit in the direction of the car.

Sufficient information is provided to the camera units so that they can be pointed at the proper cars. However, if a further level of assurance is required, the orientation of each camera can be fine-tuned. For this purpose, in step 212 the fine tuning receiver 43 is activated to sense fine-tuning signals from the fine-tuning source 69. The signals from the fine-tuning source may be coded so that the fine tuning receiver 43 can recognize a received signal as the fine-tuning signal from the car that has been designated to the respective camera unit.

Thus, in step 212, a test is perform to find the designated car with the fine tuning receiver of the respective camera unit. If the car is not found that the camera is repositioned in step 214.

In step 216 a check is performed to determine if the designated car has been in an accident. This information is obtained from the crash sensor 62 (which may measure transversal or lateral speed and velocity) and/or G-sensor 64 that measures acceleration in either the longitudinal or vertical directions. If an accident is sensed., the respective camera unit 32 is zoomed in toward the car if necessary and the position of the camera unit is frozen (step 218).

If no accident is detected in step 216 then in step 220 the current video images are collected from the respective camera unit. In step 222 a check is performed to determine if the car is still in the range of the respective camera unit. If the car is still in range, the collection of the video signals continues. If the car goes out of range, the car is switched or handed off to the designated camera of the next station (Step 224).

In this manner images are collected from the cameras of each station 18. The signals are then fed to the multiplexer 84. The multiplexer then feeds these signals to the editing table 86 (FIG. 4). The editing table assembles the video signals and data in such a manner as to generate simultaneously n different programs (e.g. six programs), each program preferably consisting of a substantially continuous stream of video signals and data from a single car, or, alternatively a sequence of cars as designated by the director. In addition, the director may insert in any video stream, video signals and data from other sources 88 coupled for example to the race car display 98, or any of the other cameras, such as cameras 20 monitoring a pit 14 or the stand 16, or the video cameras unit 76 disposed in the car.

When special events occur, the spare camera of that sector of circuit automatically locks on to the car involved in the special event. the director can take control of the spare camera 32G at any of the stations 18 or even any of the other cameras 32A-G and point it in any direction using the joy stick control 100.

To summarize, the present invention provides a system which allows generating continuous video signals and data of a sporting event such as car race using a plurality of automated stations, each having several camera units controlled remotely. This automated process provides a better, richer and cheaper way of filming fast moving events. As part of the automated process, the participant cars are equipped with a GPS receiver which provides the geographical location of the car, and a speed sensor. These signals are transmitted to a central control post and cameras for analysis. Since the central post and cameras receives the GPS signals at a delay, the position of the car can be extrapolated using the signal from the speed sensor.

The position of the camera is known from a GPS unit disposed at the camera station. From the relative positions of the camera and the respective car, the azimuth direction pan and tilt movements are calculated and transmitted to the camera unit to point the camera unit at the car as the car moves along the track.

If the car suddenly changes direction or changes its speed from a normal rate, is monitored by an accident sensor and the video signals are handled accordingly.

Fine-tuning of the car position may be achieved with a fine tuning transmitter on the car and a fine tuning receiver a the video camera unit. By using the signal from the fine tuning receiver, the camera unit can adjust itself so that the car is positioned at the center of video frame being transmitted.

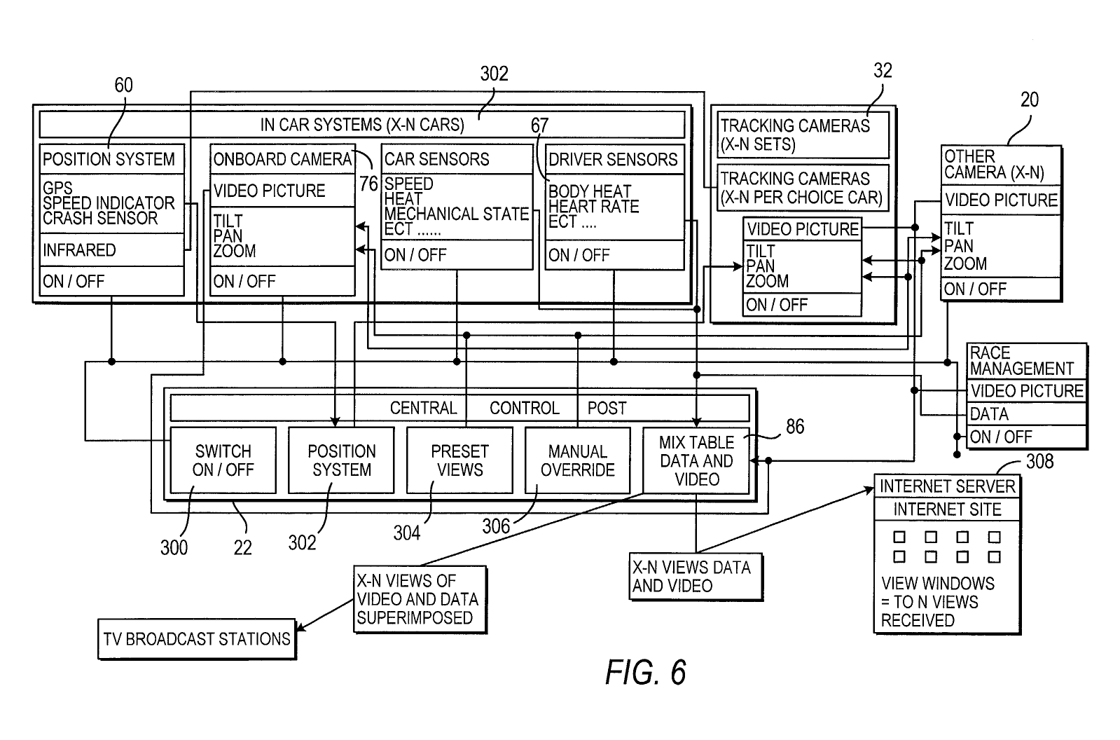

A block diagram for the system is shown in FIG. 6. As can be seen in this figure, CCP 22 is the nerve center of the system because it controls all its various elements. provided in FIG. 6, in which various modules are provided for the control and monitoring of the various elements of the subject system. The CCP 22 is provided with a control board having a power switch 300 and several modules that can access the other elements of the system and either collect data there from or provide control signals thereto. These modules include a position system module 302 that receives the position and speed of the cars and generates the control signals for the video camera units, including tilt, pan, zoom etc. Another module is the override module 306 that allows the director to override the operation of any of the elements and send his own control signals thereto, for example, through the joystick 100. The preset view module 304 generates standard default images for the programs while the camera units are off line.

As discussed above, the edit table 86 generates several programs, each program having predetermined content. For example, each program may provide streaming video signals of a particular car as the race progresses. The signals can be transmitted either to the TV broadcast stations, or to other customers by other means, such over the Internet through an Internet service provider 308.

In the description provided above, the system 10 described which is set up only temporarily. Hence the various components of the system must be positioned and tested before a race. Moreover, since the position of the stations 18 must be known precisely, each station is provided with its own GPS system, or alternatively the positions of each station must be determined by some other means. Of course, the system can also be set up permanently, in which case the positions of at least stations 18 can be determined only once.

Obviously numerous modifications may be made to this invention without departing from its scope as defined in the appended claims.

We claim:

1. A system for broadcasting a sporting event related to a moving object comprising:
a plurality of camera units disposed along a path of movement of said trajectory and generating video signals;
a position determining element arranged to detect a current position of said object; and
a controller adapted to receive said positions and to generate a commands to sequentially operate said camera units to obtain video signals of said object.

2. The system of claim 1 wherein said position determining element is coupled to the object so that they move together.

3. The system of claim 2 wherein said position determining element is a GPS.

4. The system of claim 1 wherein said event is associated with a plurality of objects, and wherein said control circuit is adapted to generate commands to said camera units to produce a plurality of video signals related to the movement of said objects.

5. The system of claim 4 further comprising a mixing element adapted to collect video signals from said camera unit and to generate several programs based on said video signals and data.

6. The system of claim 5 wherein said mixing element is adapted to generate programs, with each program being associated with one of said objects.

7. The system of claim 1 wherein a plurality objects are moving and wherein at least some of said camera units are assigned to one of said objects.

8. A system for obtaining a continuous video signal of a moving object comprising:
a camera unit responsive to remote commands to generate video signals;
a first position determining element adapted to determine a current position of said moving object; and
a controller adapted to receive said position from said position determining element and to generate said commands in accordance with said position.

9. The system of claim 8 wherein said first position determining element is mounted on said object.

10. The system of claim 9 wherein said first position determining element is a GPS.

11. The system of claim 8 further comprising a second position determining element arranged to determine the position of said camera unit, said controller being adapted to generate said commands based on the relative positions of said object and said camera.

12. The system of claim 9 further comprising sensors adapted to sense a parameter associated with said object.

13. The system of claim 12 wherein said parameter is current speed.

14. The system of claim 8 wherein said object is a vehicle controlled by a person, said system further comprising a sensor adapted to measure a parameter associated with the person or the vehicle.

15. The system of claim 14 wherein said sensor is adapted to sense a current speed of the vehicle.

16. The system of claim 15 wherein said controller is adapted to generate said commands in accordance with said current speed.

17. The system of claim 8 wherein said object is a vehicle, further comprising another camera disposed in said vehicle and adapted to transmit externally video signals from said vehicle.

18. A method of broadcasting a sporting event consisting of an object moving in a trajectory, comprising the steps of:
Providing a plurality of stations along said trajectory, each station including at least one camera adapted to generate video signals;
determining a current position of the object along said track;
selecting the station suited for covering said object at a particular time;
activating the camera associated with the selected station; and
receiving the video signals from the activated camera.

19. The method of claim 18 wherein a plurality of objects are moving generally along said trajectory, comprising determining the positions of said objects, selecting the station suited to cover each said object and said operating cameras to generate video signals of the objects.

20. The method of claim 19 further comprising a plurality of cameras for each station.

21. The method of claim 20 further comprising operating a respective camera at each station to cover each object.

22. The method of claim 21 further comprising assigning a particular camera at each station to cover a particular object.

23. The method of claim 19 further comprising receiving video signals from the cameras at a central location and mixing said signals to generate several programs.

24. The method of claim 23 further comprising transmitting said programs to at least one broadcaster.

25. The method of claim 23 further comprising designating video signals showing a particular object to each program.

26. The method of claim 19 further comprising confirming the position of each object at a respective station.

27. The method of claim 26 wherein said step of confirming includes transmitting a fine tuning signal from said objects and detecting said fine tuning signal at said stations.
